(19) United States
(12) Patent Application Publication
(10) Pub. No.: US 2023/0140223 A1
(43) Pub. Date: May 4, 2023

(54) FOLDABLE ADHESIVE WINDOW SCREENS

(71) Applicant: Karen Everon Willoughby, Chicago, IL (US)

(72) Inventor: Karen Everon Willoughby, Chicago, IL (US)

(21) Appl. No.: 17/515,873

(22) Filed: Nov. 1, 2021

(51) Int. Cl. E06B 9/52

(52) U.S. Cl. CPC E06B 9/521; E06B 2009/527

(57) ABSTRACT

The present invention comprises a novel use of adhesive hook-and-loop fastener placement on lightweight mesh for the use of insect entry prevention to homes. Mesh can be sized for any standard window, mounted and removed with easy, as well as partially opened to allow for access to window.

### FIELD OF THE INVENTION

The present invention relates to the novel combined use of hook-and-loop fastener with lightweight plastic mesh to be used as a temporary or permanent interior window screen for the prevention of insect entry into residences, while permitting entry of light and air.

### BACKGROUND

Many major U.S. cities, specifically Chicago, IL, have seen numerous and accelerated construction of high-rise residences with architecture featuring large (e.g. 100 x170 cm) windows which open. However, there are no screens provided for these windows. Residents have had to cope with (primarily) flying insects entering their residences in large numbers when the windows are open.

Neither the building management, DIY retailers, nor online retailers have ready-made solutions available. Additionally, since the large windows were created for optimum visibility, any solution would need to prevent any viewing restrictions.

Many of the residences are rentals, therefor a solution would need to be temporary and not cause any permanent change to the premises.

### BRIEF SUMMARY OF THE INVENTION

The invention takes hook-and-loop fastener and attaches it to a lightweight plastic mesh on seven points. The opposite side of the hook-and-loop fastener is adhesive and attached to the inside frame of the window. Because the mesh is thin, it does not obstruct the view from inside the residence, but also does its primary function of keeping insects out.

The hook-and-loop fastener allows the resident to lift it partially from the window frame in order to open the window, and then replace it so that it remains sealed around the frame of the window.

If the window will remain closed for an extended period of time, or the window will be opened at a time when insects are not a concern, the lightweight plastic mesh can be removed completely from the window and folder for storage until needed.

### BRIEF DESCRIPTION OF THE FIGURES

FIGS. 1a-b: How the hook-and-loop fastener is attached to the lightweight plastic mesh

FIGS. 2a-b: How the hook-and-loop fastener is attached to the window

FIG. 3a: How the hook-and-loop fastener is separated so the window can be opened or closed

FIG. 4: How the hook-and-loop fastener is replaced

FIG. 5: Lightweight plastic mesh folded for storage

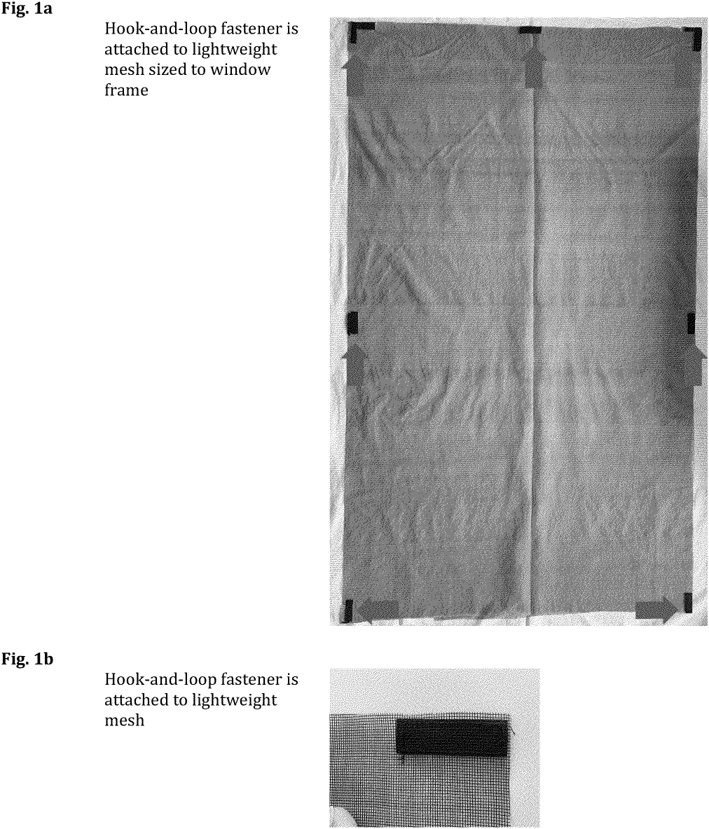

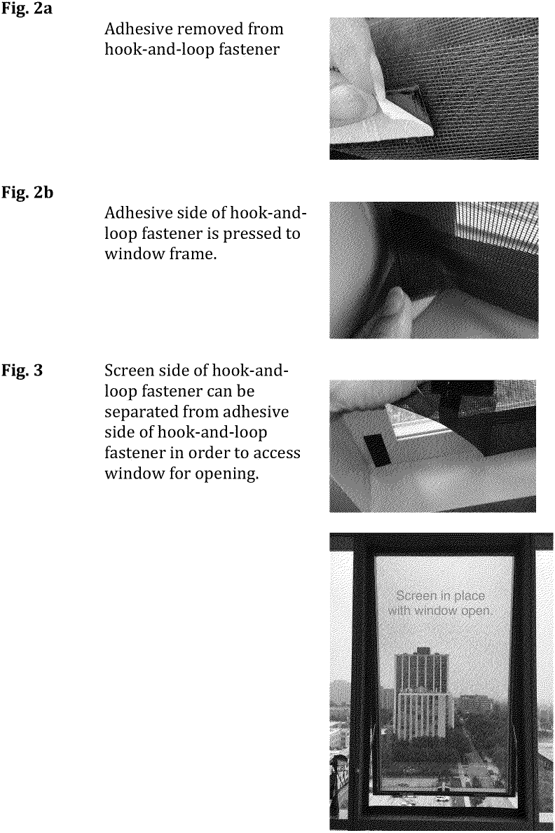

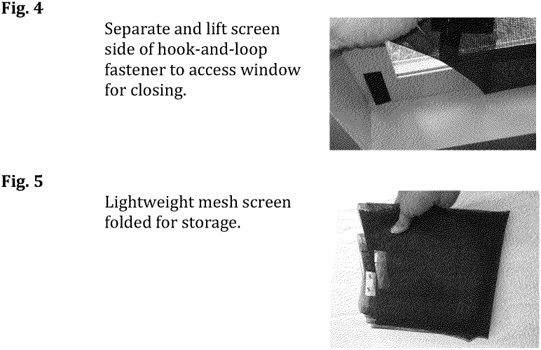

What is claimed is:

1. Use of adhesive hook-and-loop fastener on lightweight mesh.

2. Lightweight window screen can be easily mounted on windows to prevent insect entry.

3. Lightweight window screen can be partially opened or removed completely from window, folded, stored, and re-mounted as needed.
